(19) United States
(12) Patent Application Publication
(10) Pub. No.: US 2023/0334878 A1
(43) Pub. Date: Oct. 19, 2023

(54) CONDITION MONITORING APPARATUS AND STORAGE MEDIUM

(71) Applicant: DENSO CORPORATION, Kariya-city (JP)

(72) Inventor: Yosuke SAKAI, Kariya-city (JP)

(21) Appl. No.: 18/339,103

(22) Filed: Jun. 21, 2023

Related U.S. Application Data
(63) Continuation of application No. PCT/JP2021/042971, filed on Nov. 24, 2021.

(30) Foreign Application Priority Data
Dec. 23, 2020 (JP) 2020-213695

(51) Int. Cl. G06V 20/59; B60W 40/08

(52) U.S. Cl. CPC G06V 20/59; B60W 40/08; B60W 2540/043

(57) ABSTRACT

A condition monitoring apparatus includes an image processing unit that processes an image picked up by an in-vehicle camera capturing an image of an occupant in a vehicle, a recognition condition information acquisition unit that acquires recognition condition information specified for a vehicle or a specified occupant, and an occupant detection unit that sets an image recognition condition by using the recognition condition information, recognizes an image processed by the image processing unit under the image recognition condition, and detects the specified occupant.

### CROSS-REFERENCE TO RELATED APPLICATION

The present application is based on and claims the benefit of priority from earlier Japanese Patent Application No. 2020-213695 filed on Dec. 23, 2020, the description of which is incorporated herein by reference.

### BACKGROUND

### Technical Field

The present disclosure relates to a condition monitoring apparatus and a storage medium.

### RELATED ART

A configuration has been provided in which in-vehicle camera for picking up an image of the interior of a vehicle is provide, and occupants are recognized based on a difference between images picked up by the in-vehicle camera before doors are opened or closed and after the doors are opened or closed to detect a driver.

### SUMMARY

An aspect of the present disclosure provides a condition monitoring apparatus, including: an image processing unit that processes an image picked up by an in-vehicle camera capturing an image of an occupant in a vehicle; a recognition condition information acquisition unit that acquires recognition condition information specified for a vehicle or a specified occupant; and an occupant detection unit that sets an image recognition condition by using the recognition condition information, recognizes an image processed by the image processing unit under the image recognition condition, and detects the specified occupant.

### BRIEF DESCRIPTION OF THE DRAWINGS

In the accompanying drawings:

FIG. 1 is a functional block diagram illustrating an embodiment;

FIG. 2 is a flowchart (part 1);

FIG. 3 is a diagram illustrating characteristic information when a specific occupant is a driver (part 1);

FIG. 4 is a diagram illustrating characteristic information when a specific occupant is a driver (part 2);

FIG. 5 is a diagram illustrating characteristic information when a specific occupant is a driver (part 3); and

FIG. 6 is a flowchart (part 2).

### DETAILED DESCRIPTION OF THE PREFERRED EMBODIMENTS

A configuration has been provided in which in-vehicle camera for picking up an image of the interior of a vehicle is provide, and occupants are recognized based on a difference between images picked up by the in-vehicle camera before doors are opened or closed and after the doors are opened or closed to detect a driver. (JP-A-2012-44404)

However, occupants other than the driver may be visible within an angle of view of the in-vehicle camera depending on a position at which the in-vehicle camera is disposed and a vehicle environment. For example, in a case of an automobile, other than the driver, occupants on the passenger seat and rear seats may be visible. In a case of a bus, other than the driver, occupants on the customer seats may be visible. In these cases, if images picked up by the in-vehicle camera are processed, since a plurality of faces are detected in the processed images, the driver may not be detected from the plurality of passengers.

As described above, when a plurality of faces are detected in the processed images due to the visibility of a plurality of passengers in the angle of view of the in-vehicle camera, a specific passenger cannot be detected appropriately from the plurality of passengers.

The present disclosure aims to appropriately detect a specific occupant from a plurality of occupants even when a plurality of faces are detected in a processed image due to visibility of a plurality of occupants within an angle of view of an in-vehicle camera.

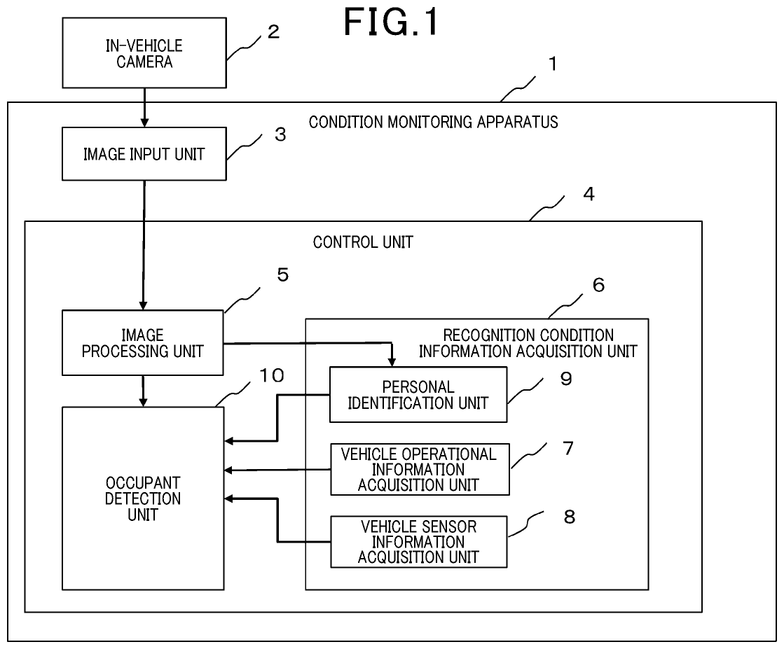

Hereinafter, an embodiment will be described with reference to the drawings. As illustrated in FIG. 1, a condition monitoring apparatus 1 detects a specific occupant in a vehicle such as an automobile and a bus, and monitors a state of the detected specific occupant. For example, the apparatus monitors a state of a driver as the specific occupant and detects an eye opening degree, expression, and the like of the driver to determine whether driving operation can be performed normally or to issue a call for attention as needed.

The condition monitoring apparatus 1 includes an image input unit 3 that receives images from an in-vehicle camera 2 and a control unit 4. The in-vehicle camera 2 is mounted to a part at which images of the whole vehicle interior can be captured, and outputs the captured images to the condition monitoring apparatus 1. Since the in-vehicle camera 2 is mounted to a part at which images of the whole vehicle interior can be captured, the images captured by the in-vehicle camera 2 may include faces of a plurality of occupants. The in-vehicle camera 2 may not be necessarily mounted to the part at which images of the whole vehicle interior can be captured. Even if the whole vehicle interior can be captured, the images captured by the in-vehicle camera 2 may include faces of a plurality of occupants.

If receiving images output from the in-vehicle camera 2, the image input unit 3 outputs the input images to the control unit 4. The control unit 4 is mainly configured by a microcomputer and includes a CPU, a ROM, a RAM, and an I/O and performs various processes based on a program stored in the ROM. The control unit 4 includes, as configurations performing the processes, an image processing unit 5, a recognition condition information acquisition unit 6, and an occupant detection 10. Functions provided by the control unit 4 can be provided by software stored in the ROM, which is a tangible memory and a computer executing the software, only software, only hardware, or the combination thereof. The program executed by the control unit 4 includes a condition monitoring program.

If receiving an image output from the image input unit 3, the image processing unit 5 processes the received image and outputs the processed image to a personal identification unit 9 and an occupant detection unit 10.

The recognition condition information acquisition unit 6 acquires recognition condition information specified for a vehicle or a specified occupant. The recognition condition information acquisition unit 6 includes a vehicle operational information acquisition unit 7, a vehicle sensor information acquisition unit 8, and the personal identification unit 9.

The vehicle operational information acquisition unit 7 acquires vehicle operational information and outputs the acquired vehicle operational information to the occupant detection unit 10. The vehicle operational information includes information indicating a position at which the in-vehicle camera 2 is disposed, for example, information indicating a position at which devices concerning driving operation such as a steering wheel and a shift lever, information concerning wear, information indicating motions, and the like. The aspect for acquiring the vehicle operational information is not limited and may be, for example, acquired by reading from a storage medium storing the vehicle operational information or by manual input by a user.

The vehicle sensor information acquisition unit 8 acquires vehicle sensor information form a vehicle sensor, an electronic control device, or the like mounted to the vehicle and outputs the acquired vehicle sensor information to the occupant detection unit 10. The vehicle sensor information includes information indicating a vehicle speed, information indicating a shift position, information indicating a seating location, information indicating an operation state of a start button and an attaching stated of a seat belt, and the like.

Receiving a processed image from the image processing unit 5, the personal identification unit 9 performs personal identification by using the received processed image and outputs a personal identification result indicating the result of the personal identification to the occupant detection unit 10.

The occupant detection unit 10 receives vehicle operational information output from the vehicle operational information acquisition unit 7, vehicle sensor information output from the v, and a personal identification result output from the personal identification unit 9, and sets an image recognition condition by using the received vehicle operational information, vehicle sensor information, and personal identification result. In this case, the occupant detection unit 10 may use all of or any one of the vehicle operational information, vehicle sensor information, and personal identification result to set the image recognition condition. That is, the occupant detection unit 10 may set the image recognition condition by using, for example, only the vehicle operational information or the personal identification result. The occupant detection unit 10 may set the image recognition condition by using, for example, the vehicle operational information and the personal identification result.

On receiving the processed image from the image processing unit in a state in which the image recognition condition is set, the occupant detection unit 10 recognizes the received processed image under the set image recognition condition to detect a specific occupant. That is, when a driver of a bus is detected as a specific occupant, the occupant detection unit 10 sets an image recognition condition for a bus or a driver by using characteristic information, whereby the driver of the bus can be detected.

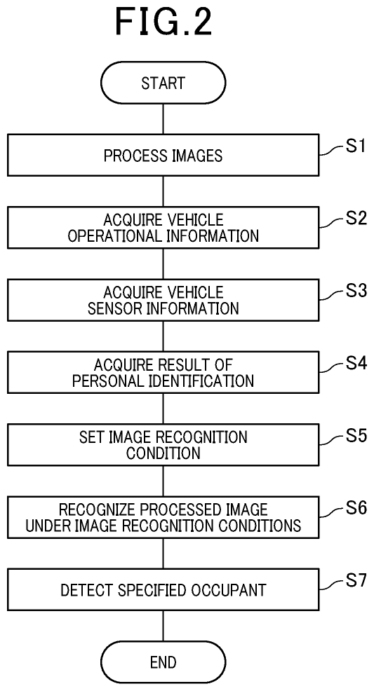

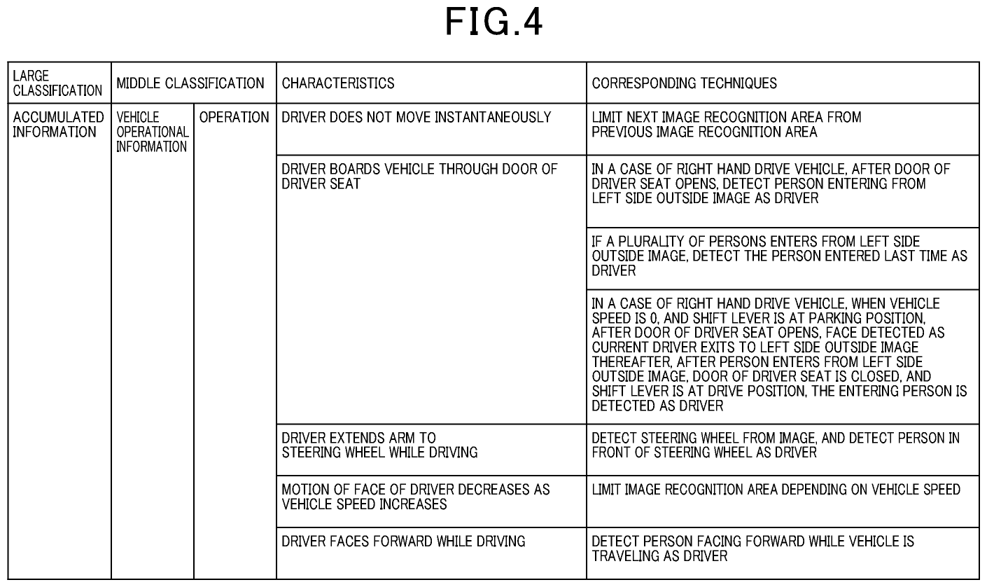

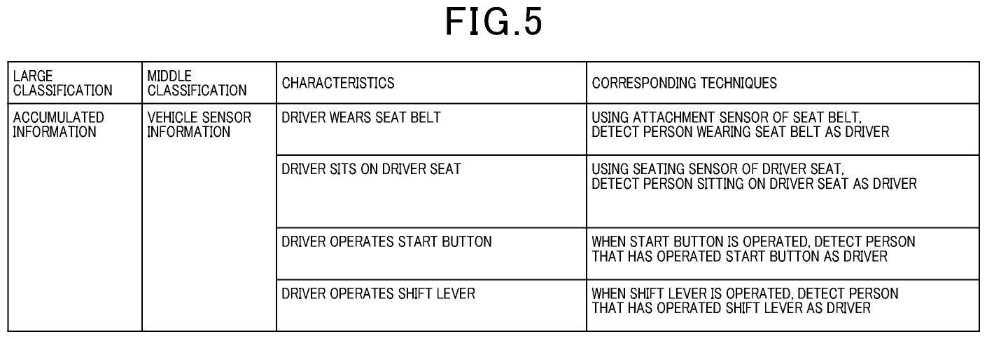

Next, effects of the above configuration will be described with reference to FIG. 2 to FIG. 6.

The control unit 4 waits establishment of a start event of a condition monitoring process. If the start event of the condition monitoring process is established, the control unit 4 starts the condition monitoring process. The timing at which the condition monitoring process is started is arbitrary. When a driver is detected as a specific occupant, if it is necessary to monitor the driver all the time, the start event of the condition monitoring process may be established at predetermined intervals during the vehicle is traveling.

Starting the condition monitoring process, the control unit 4 processes images received from the in-vehicle camera 2 through the image input unit 3 (S1). S1 corresponds to an image processing step. The control unit 4 acquires vehicle operational information (S2), acquires vehicle sensor information (S3), and acquires the result of the personal identification (S4). S2 to S4 correspond to recognition condition information acquisition step. The control unit 4 uses at least one of the vehicle operational information, the vehicle sensor information, and the result of the personal identification to set an image recognition condition (S5). The control unit 4 may acquired at least one of the vehicle operational information, the vehicle sensor information, and the result of the personal identification to set the image recognition condition by using the acquired one. The control unit 4 may process images, acquires vehicle operational information, and acquires vehicle sensor information acquires vehicle sensor information.

The control unit 4 receives the processed image from the image processing unit 5, recognizes the received processed image under the image recognition conditions set by using the vehicle operational information, the vehicle sensor information, and the result of the personal identification (S6), detects a specified occupant (S7, corresponding to an occupant detection step), and ends the condition monitoring process.

The image recognition condition will be described. Typically, in a vehicle, the positional relationship among seats is fixed. That is, the positional relationship among a driver seat, a passenger seat, and rear seats is fixed, the driver seat and the passenger seat are arranged in the vehicle width direction, and the rear seats are behind the driver seat and the passenger seat. In the bus, the positional relationship between the driver seat and the customer seats is fixed, and the customer seats are behind the driver seat. In the vehicle, positions are fixed at which devices concerning driving operation such as a steering wheel and a shift lever are disposed. That is, the positions at which devices concerning driving operation are disposed are around the driver seat. In a case of commercial vehicles such as a bus and a truck, wear of drivers is often provided. Motion of drivers before and during driving is common. For example, before driving, the driver often adjusts a rearview mirror and positions of a seat and operates a navigational device to set a destination. During driving, the driver holds the steering wheel and the shift lever. The image recognition condition is set by using the vehicle operational information focusing on such characteristics.

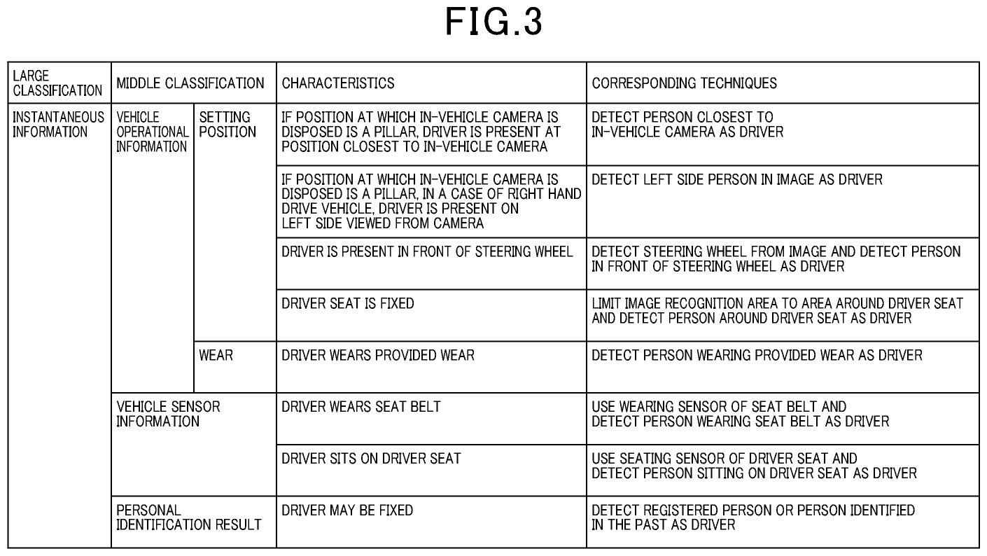

Techniques used when an occupant to be detected is a driver and the driver is detected as a specific occupant will be described with reference to FIG. 3 to FIG. 5. Contents of FIG. 3 to FIG. 5 are examples of characteristics of a driver to be detected and are not the limitations. The control unit 4 categorizes the timing at which the driver is detected as large classification. At the timing at which the driver is detected, the driver is detected based on instantaneous information or accumulated information.

When the driver is detected based on instantaneous information, the control unit 4 sets the image recognition condition by using the vehicle operational information, the vehicle sensor information, and the personal identification result as middle classification. In this case, the control unit 4 sets, as the vehicle operational information, information on positions at which the in-vehicle camera 2 and the devices concerning driving operation are set and on wear. For example, if the position at which the in-vehicle camera 2 is disposed is A pillar, since the driver has characteristics that the driver is present at the position closest to the in-vehicle camera 2, the control unit 4 sets the image recognition condition so as to detect a person closest to the in-vehicle camera 2 as a driver. For example, in a case of a commercial vehicle such as a bus or a truck, since the driver has characteristics that the driver wears provided clothing such as a regulation cap and a uniform, the control unit 4 sets the image recognition condition so as to detect a person wearing the provided wear as a driver. For other characteristics, the image recognition condition is set so as to detect the person corresponding to the characteristics as a driver.

When the driver is detected based on accumulated information, the control unit 4 sets the image recognition condition by using the vehicle operational information and the vehicle sensor information as middle classification. In this case, the control unit 4 sets, as the vehicle operational information, information on motions. For example, since a driver gets in the vehicle through a door of the driver seat, in a case of a right hand drive vehicle, the control unit 4 sets the image recognition condition so as to detect a person entering from the left outside the image after the door of the driver seat opens, as a driver. For example, since the driver operates the start button, the shift lever, and the seat belt, when the start button, the shift lever, or the seat belt is operated, the control unit 4 sets the image recognition condition so as to detect a person that has operated the start button, the shift lever, or the seat belt as the driver. For other characteristics, the image recognition condition is set so as to detect the person corresponding to the characteristics as a driver.

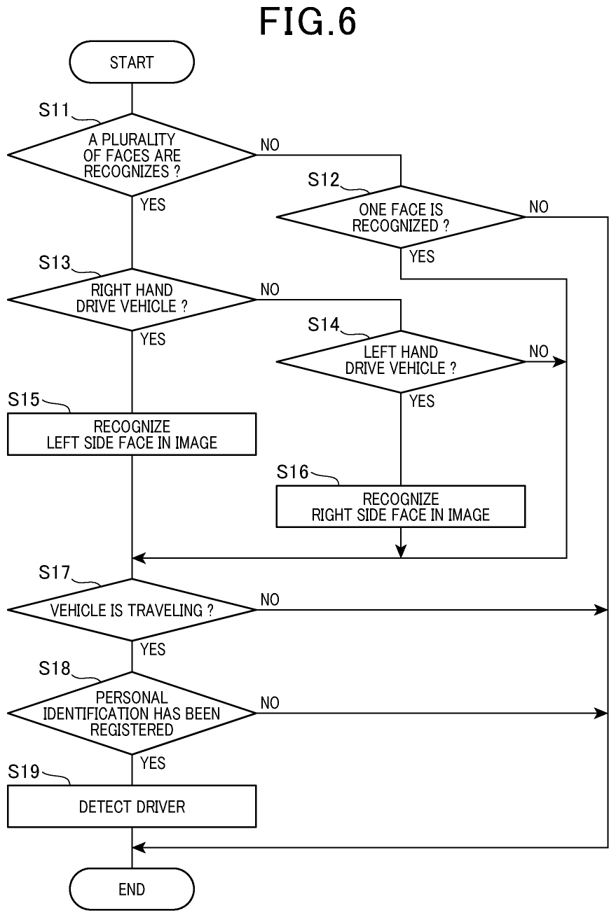

Specifically, a process for recognizing the processed image under the image recognition condition to detect a driver will be described with reference to FIG. 6. Herein, as the image recognition condition, a case in which the position at which the steering wheel is disposed, a vehicle state, and a personal identification state are set will be described.

The control unit 4 determines whether one or a plurality of faces have been recognized in the processed image (S11, S12). If determining that a plurality of faces have been recognized in the processed image (S11: YES), the control unit 4 determines whether the vehicle is a right hand drive vehicle or a left hand drive vehicle (S13, S14). If determining that the vehicle is a right hand drive vehicle (S13: YES), the control unit 4 recognizes a left side face in the image (S15). If determining that the vehicle is a left hand drive vehicle (S14: YES), the control unit 4 recognizes a right side face in the image (S16). The control unit 4 determines whether the vehicle is traveling (S17). If determining that the vehicle is traveling (S17: YES), the control unit 4 determines whether personal identification has been registered (S18). If determining that the person has been registered or identified in the past, and the personal identification has been registered (S18: YES), the control unit 4 detects a driver (S19).

In the above, a case has been described in which, as the image recognition conditions, the position at which the steering wheel is disposed, the vehicle state, and the personal identification state are set. However, as illustrated in FIG. 3 to FIG. 5, since there are various characteristics of drivers, any characteristics can be employed for detecting a driver. If the number of the employed characteristics increases, reliability can be increased. However, since it is concerned that long processing time is required, items and the number of characteristics employed for detecting a driver may be determined depending on the required reliability and processing time.

In the above, a case is exemplified in which when detection is performed based on instantaneous information, the image recognition condition is set by using the vehicle operational information, the vehicle sensor information, and the personal identification result. However, the image recognition condition may be set by using at least any of the vehicle operational information, the vehicle sensor information, and the personal identification result. In a case in which when detection is performed based on accumulated information, the image recognition condition is set by using the vehicle operational information and the vehicle sensor information. However, the image recognition condition may be set by using at least any of the vehicle operational information and the vehicle sensor information.

In the above, a case is exemplified in which a driver is detected as a specific occupant. However, an occupant on a passenger seat, rear seats, or customer seats may be detected. For example, when an occupant on the passenger seat is detected as a specific occupant, in a case of a right hand drive vehicle, the occupant on the passenger seat has characteristic that the occupant is present on the right side in the image. Hence, the control unit 4 may set the image recognition condition so as to detect the person present on the right side in the image as the occupant on the passenger seat. For example, when the occupant on the passenger seat is detected as a specific occupant, the occupant tends to turn his face laterally when the occupant talks with the driver. Hence, the image recognition condition may be set so as to detect a person who tends to turn his face laterally as the occupant on the passenger seat. That is, setting the image recognition condition according to the characteristics of an occupant to be detected can detect any occupant.

As described above, according to the present embodiment, the following effects can be obtained. The condition monitoring apparatus 1 sets the image recognition condition by using the recognition condition information, recognizes processed images under the image recognition condition, and detects a specific occupant. Setting information characteristic of a vehicle or a specific occupant as recognition condition information can recognize the processed image based on the information characteristic of the vehicle or a specific occupant, whereby the specific occupant can be detected appropriately. Hence, even when a plurality of faces are detected in the processed images due to the visibility of a plurality of passengers in the angle of view of the in-vehicle camera 2, a specific passenger can be detected appropriately from the plurality of passengers.

The condition monitoring apparatus 1 sets the image recognition condition by using the vehicle operational information. A specific occupant can be detected based on the vehicle operational information. Setting the image recognition condition by using information indicating a position at which the in-vehicle camera 2 is disposed, information indicating positions at which a steering wheel and a shift lever are disposed, information concerning wear, and information indicating motions can apply the information indicating a position at which the in-vehicle camera 2 is disposed, the information indicating positions at which the steering wheel and the shift lever are disposed, the information concerning wear, and the information indicating motions, as the information characteristic of the specific occupant.

The condition monitoring apparatus 1 sets the image recognition condition by using the vehicle sensor information. A specific passenger can be detected based on the vehicle sensor information. Setting information indicating a vehicle speed, information indicating a shift position, information indicating a seating location, information indicating an operation state of a start button, and information indicating an attaching stated of a seat belt as the vehicle sensor information can apply the information indicating a vehicle speed, information indicating a shift position, information indicating a seating location, information indicating an operation state of the start button and information indicating an attaching stated of the seat belt as information characteristic of the specific occupant.

The condition monitoring apparatus 1 sets the image recognition condition by using a personal identification result. A specific passenger can be detected based on the personal identification result.

The condition monitoring apparatus 1 sets the image recognition condition based on instantaneous information, whereby a specific passenger can be detected quickly. Setting the image recognition condition based on accumulated information can increase the amount of information for detecting a specific passenger, whereby accuracy in detection can be increased.

The present disclosure has so far been described based on some embodiments. However, the present disclosure should not be construed as being limited to these embodiments or the structures. The present disclosure should encompass various modifications, or modifications within the range of equivalence. In addition, various combinations and modes, as well as other combinations and modes, including those which include one or more additional elements, or those which include fewer elements should be construed as being within the scope and spirit of the present disclosure.

The control unit and the method executed by the control unit in the present disclosure may be implemented by a dedicated computer including a processor and a memory programmed to execute one or more functions embodied by computer programs. Alternatively, the control unit and the method executed by the control unit described in the present disclosure may be implemented by a dedicated computer including a processor formed of one or more dedicated hardware logical circuits. The control unit and the method executed by the control unit described in the present disclosure may be implemented by one or more dedicated computers including a combination of a processor and a memory programmed to execute one or more functions and a processor including one or more hardware logical circuits. The computer programs may be stored, as instructions to be executed by a computer, in a computer-readable non-transitory tangible storage medium.

According to an aspect of the present disclosure, the image processing unit (5) processes an image picked up by an in-vehicle camera capturing an image of an occupant in a vehicle. A recognition condition information acquisition unit (6) acquires recognition condition information specified for a vehicle or a specified occupant. An occupant detection unit (10) sets an image recognition condition by using the recognition condition information, recognizes an image processed by the image processing unit under the image recognition condition, and detects the specified occupant.

An image recognition condition is set by using the recognition condition information, a processed image is recognized under the image recognition condition, and a specified occupant is detected. Setting information characteristic of a vehicle or a specific occupant as recognition condition information can recognize the processed image based on the information characteristic of the vehicle or a specific occupant, whereby the specific occupant can be detected appropriately. Hence, even when a plurality of faces are detected in the processed images due to the visibility of a plurality of passengers in the angle of view of the in-vehicle camera 2, a specific passenger can be detected appropriately from the plurality of passengers.

What is claimed is:

1. A condition monitoring apparatus, comprising:
an image processing unit that processes an image picked up by an in-vehicle camera capturing an image of an occupant in a vehicle;
a recognition condition information acquisition unit that acquires recognition condition information specified for a vehicle or a specified occupant; and
an occupant detection unit that sets an image recognition condition by using the recognition condition information, recognizes an image processed by the image processing unit under the image recognition condition, and detects the specified occupant.

2. The condition monitoring apparatus according to claim 1, wherein
the recognition condition information acquisition unit includes a vehicle operational information acquisition unit that acquires vehicle operational information, and
the occupant detection unit sets image recognition condition by using the vehicle operational information.

3. The condition monitoring apparatus according to claim 2, wherein
the occupant detection unit sets an image recognition condition by using at least one of information indicating a position at which the in-vehicle camera is disposed, information indicating a position at which a device concerning driving operation is disposed, information concerning wear, and information indicating a motion.

4. The condition monitoring apparatus according to claim 1, wherein
the recognition condition information acquisition unit includes a vehicle sensor information acquisition unit that acquires vehicle sensor information, and
the occupant detection unit sets an image recognition condition by using the vehicle sensor information.

5. The condition monitoring apparatus according to claim 4, wherein
the occupant detection unit sets an image recognition condition by using, as the vehicle sensor information, at least any of information indicating a vehicle speed, information indicating a shift position, information indicating a seating location, information indicating an operation state of a start button and an attaching stated of a seat belt.

6. The condition monitoring apparatus according to claim 1, wherein
the recognition condition information acquisition unit includes a personal identification unit that performs personal identification by using an image processed by the image processing unit, and
the occupant detection unit sets the image recognition condition by using a personal identification result of the personal identification unit.

7. The condition monitoring apparatus according to claim 1, wherein
the occupant detection unit sets the image recognition condition based on instantaneous information.

8. The condition monitoring apparatus according to claim 1, wherein
the occupant detection unit sets the image recognition condition based on accumulated information.

9. A storage medium in which a condition monitoring program is stored to cause a computer to execute processing, the processing comprises:
processing an image picked up by an in-vehicle camera capturing an image of an occupant in a vehicle;
acquiring recognition condition information specified for a vehicle or a specified occupant; and
setting an image recognition condition by using the recognition condition information, recognizing the image processed by the image processing step under the image recognition condition, and detecting a specified occupant.
